(19) United States
(12) Patent Application Publication
(10) Pub. No.: US 2008/0009308 A1
(43) Pub. Date: Jan. 10, 2008

(54) Apparatus and Method of Direct Mode Radio Communication

(75) Inventors: Eitan Bar, Tel-Aviv (IL); Leonid Berman, Tel-Aviv (IL); Dan Dory, Tel-Aviv (IL); Ran Teshuva, Tel-Aviv (IL)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 10/597,623

(22) PCT Filed: Sep. 29, 2004
(86) PCT No.: PCT/EP04/52367

§ 371 Date: Aug. 1, 2006

(30) Foreign Application Priority Data
Dec. 13, 2003 (GB) 0328923.8

(51) Int. Cl. H04Q 7/20; H04M 1/00

(52) U.S. Cl. 455/550.1; 455/446

(57) ABSTRACT

A method of direct mode radio communication is disclosed, characterised by a mobile station (MS) maintaining at least a first direct mode group set (DGS) comprising an ordered list of two or more user groups together with their respective associated direct mode radio frequency (RF) channels. The groups are maintained for the purpose of scanning for alternative RF activity among some or all of said groups.

### TECHNICAL FIELD

The invention relates to apparatus and method of direct mode radio communication. In particular, it relates to group calls and other services for direct mode radio communication.

### BACKGROUND

Digital voice and data communications that use Radio Frequencies (RF) as their transmission medium are conventionally classified into Private Mobile Radio (PMR) or Specialized Mobile Radio (SMR) technologies.

All the various implementations that evolved from these fundamental technologies are modelled around a network of static, interconnected (“Trunked”) radio communication nodes, collectively known as a trunked radio network. This network is responsible for efficiently controlling and managing the available medium resources, specifically RF spectra and time division multiple access (TDMA) multiplexing, in order to maximise resource utilization, reliability and consistency.

Moreover, the network is responsible for synchronizing the various radio terminals (mobile stations, or MS) both in terms of frequency and timing, to allocate the medium resources to each MS individually and to funnel all the signals between MSs through the network paths.

In order to supplement this primary model in cases where access to the trunked network system is not available (for example due to range, capacity or operational considerations) a complementary communication model was developed, namely, the “Direct” radio link. As opposed to the trunked radio network, the direct radio link relegates the controlling duties of the trunked system to the MS initiating the direct radio link.

However, unsurprisingly not all the facilities that a central trunked system is capable of providing in a trunked mode of operation (TMO) can easily be replicated in the supplementary direct mode of operation (DMO), even if these facilities are highly desirable.

The purpose of the present invention is to provide one such facility in direct mode operation, namely a DMO talk group scan functionality.

### SUMMARY OF THE INVENTION

In a first aspect, the present invention provides a method of direct mode radio communication, as claimed in claim 1.

In a second aspect, the present invention provides a mobile station, as claimed in claim 17.

Further features of the present invention are as defined in the dependent claims.

Embodiments of the present invention will now be described by way of example with reference to the accompanying drawings, in which:

### BRIEF DESCRIPTION OF THE DRAWINGS

FIG. 1 is a schematic diagram depicting mobile stations belonging to one or more of three user groups, in accordance with an embodiment of the present invention.

FIG. 2 is a schematic diagram depicting mobile stations bellowing to one or more of three user groups, and wherein a first mobile station initiates a call, in accordance with an embodiment of the present invention.

FIG. 3 is a schematic diagram depicting mobile stations bellowing to one or more of three user groups, and wherein a second mobile station initiates a call, in accordance with an embodiment of the present invention.

### DETAILED DESCRIPTION

A method of DMO service scanning is disclosed. This method is not limited to any particular PMR or SMR device, but for the sake of clarity the following description is given with reference to the ETSI TErrestrial Trunked RAdio (TETRA) standard (see www.etsi.org).

According to the current TETRA standard, a TETRA MS operating in direct mode monitors its channel for activity relating to the user group to which it belongs (e.g. a set of one or more associated MSs which share the same group address).

In particular, a TETRA MS operating in Direct Mode on a selected RF channel, and while having no knowledge of the selected channel's state, continuously monitors this channel for any TETRA specific RF activity.

Once any TETRA specific RF activity is detected, the MS synchronizes with the first fully decoded TETRA direct mode synchronization burst (DSB). If this synchronization burst is addressed to the group that the MS (110, 120, 130) is currently set to receive any calls or other TETRA services from, it joins the call or responds to the service.

Similarly, a TETRA MS that initiates a call or another TETRA service does so acting as a DMO master MS on its RF channel.

Thus in both DMO monitoring and DMO master roles, an MS abiding by the TETRA standard only addresses one channel and is consequently ignorant of any other TETRA activity that might be taking place on another RF channel, and which may be of interest to the user of the MS.

An example scenario is where a middle manager at a work site or a middle ranking officer in the armed forces typically has a role of relaying instructions down the chain of command;

If they have initiated a call to a group in order to relay instructions to their staff, then the manager or officer could not become aware of a higher-ranking manager or commander initiating a call to a group of middle ranking staff to which they belong being conducted at the same time, but which typically they would rather join.

In short, the current DMO communication methodology can break a chain of information or command because a DMO mobile handset will monitor and connect only over one channel at a time, and does not monitor activity from other channels whilst monitoring a specific one.

The present invention provides a method of multi channel scanning in direct mode operation. Such multi channel scanning enables, inter alia, a method of adapting the trunked feature ‘talk group scan’ (TGS) to direct mode operation.

In essence, TMO TGS monitors channel activity in the networked system and enables detectability and selection of other groups on other channels by an MS.

A novel method of DMO multi-channel scanning is now described below for a TETRA system in a DMO TGS scenario; the current TETRA DMO protocols, procedures and conventions described in the standard (see ETS 300 396-3 at http://www.etsi.org) are observed.

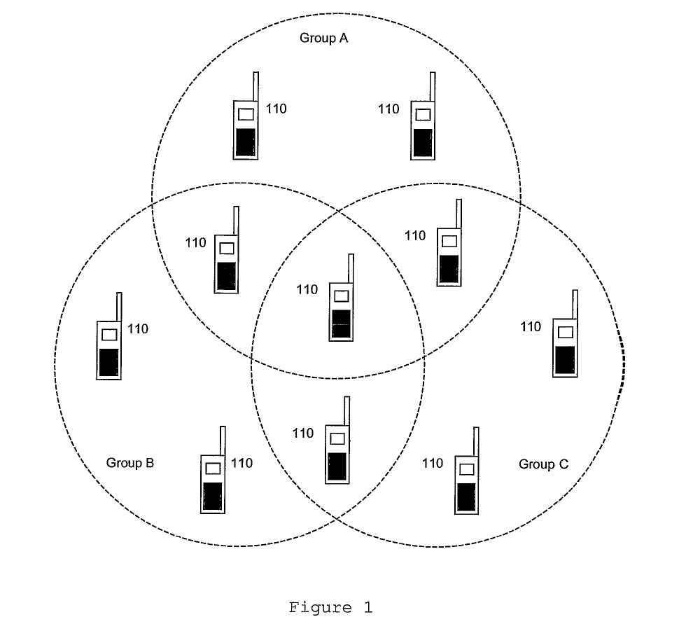

Referring to FIG. 1, in an embodiment of the present invention, a plurality of MSs 110 is depicted arranged in a number of groups indicated as Group A, Group B and Group C. Each MS 110 maintains at least a first selectable DMO group set (DGS) to choose from, where a DGS comprises a list of groups and their respective direct mode RF channel. Selection may be automatic or by the user.

It is assumed that all the MSs 110 party to the various groups for a given scenario will use the same DGS.

Each group in a DGS is assigned a unique sequence number (USN) related to their position in the list.

An MS 110 conducts a channel surveillance procedure for those RF channels associated with the groups in the selected DGS whose channel state is free/unknown.

The TETRA DMO standard ETS 300 396-3, section 8.4.2.2.1 states:
A DM-MS which has just been switched into direct mode operation or following initial power up in direct mode shall conduct continuous monitoring of the selected DM radio frequency carrier in order to detect any DSBs (direct mode synchronization bursts) present and decode any layer 2 information available.
Continuous monitoring of the DM radio frequency carrier means that a DM-MS shall sample the DM radio frequency carrier at a sufficient rate so that the presence of a DSB may be determined.
A DM-MS shall conduct the procedure to determine the initial state of the DM radio frequency carrier over a period of at least 19 frame durations or until DSBs are detected.

In an embodiment of the present invention, rather than the single selected channel described in the TETRA DMO standard passage above, the surveillance procedure steps though the RF channels associated with the groups periodically, to determine if there is any RF activity. Any order of stepping through the RF channels is acceptable. For example, one such procedure involves taking five one-millisecond samples on consecutive group RF channels per frame.

By interleaving samplings of the RF channels in this manner, all the group channels are monitored essentially simultaneously until either at least a period of 19 frames (approximately 1 second) has elapsed or one or more DSBs are detected.

It will be clear to a person skilled in the art that in principle the surveillance procedure may continue indefinitely.

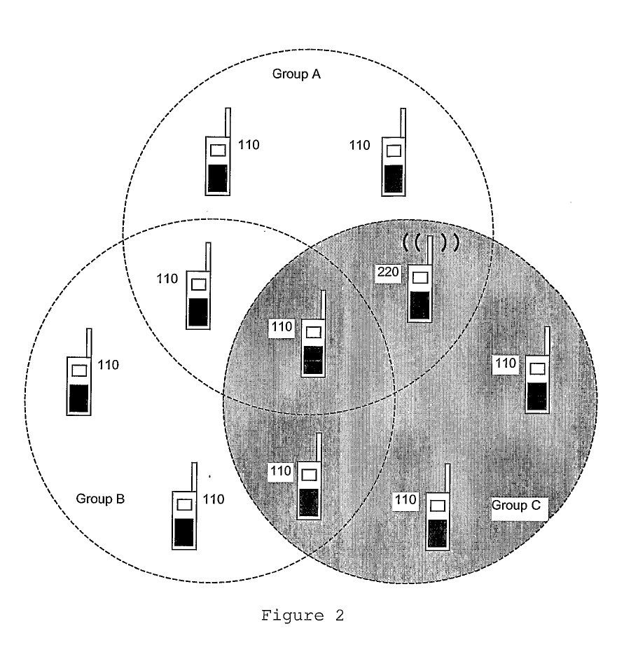

Referring now to FIG. 2, if there is currently no group activity on any of the surveyed channels, then the first TETRA call or service to start on any of the groups determines the physical and logical time division pattern (TDP) for all surveyed channels. An MS initiating such a call is called a master MS, depicted in FIG. 2 as MS 220. In the case of FIG. 2, an MS 220 of a mid-ranking manager that is a member of two groups is depicted initiating a call to one of these groups.

The other TETRA MSs 110 detecting this activity, whether a member of the addressed group or more generally a member of the DGS, synchronise to this timing regime, adopting the same frame and slot numbering as the Master MS 220.

Having found a TETRA call or service from among the groups of the selected DGS, a second group channel survey mode is now employed:

An embodiment of the present invention exploits currently unassigned time slots available during a call or service, for example in TETRA time slot #3 on each of the Request Bit Map associated frames 1, 4, 7, 9, 10, 13, 15 and 16 (see ETS 300 396-3 sections 8.4.7.9 and 9.6.13).

Each Master MS 220 currently making a call will transmit a presence signal burst on a specific time slot in such a frame on its own RF channel, the specific frame being assigned according to the corresponding group position in the DGS. Thus for example, a Master MS 220 transmitting to a third group in a DGS will use a time slot in frame 7, whilst an MS transmitting to a seventh group in the DGS will use a time slot in frame 15. Any relationship that uniquely maps DGS group position to a specific time-slot is acceptable.

Typically, each slave or idle MS 110 (a slave MS is party to a call, while an idle MS is not) shall listen during these time slots to the relevant channel for a presence signal indicating activity in an alternative group.

Clearly, a Master MS 220 may also listen to the time slots of other groups than its own in a similar manner.

This method is referred to as the DMO Coupled Control Channel (DCCC).

In an alternative embodiment, a specific RF channel is assigned on which all Master MSs 220 transmit their presence signal bursts at the relevant times and to which all MSs listen at the relevant times. This method is referred to as the DMO Alternative Control Channel (DACC).

In both the DCCC and DACC cases, the first TETRA Master MS 220 signals all call or service recipients that the request bit map associated time slots are not available for random access requests (see ETS 300 396-3 section 9.6.13), leaving them reserved for the DCCC and DACC schemes described above.

Table 1 overleaf illustrates an example time division pattern for the DMO Coupled Control Channel method, for a DGS containing groups A-H:

TABLE 1
Example TDP for DCCC method.

| Fr 1 | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | RF channel A |
|---|---|---|---|---|---|---|---|---|---|---|---|---|---|---|---|---|---|---|
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | RF channel B |
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | RF channel C |
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | RF channel D |
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | RF channel E |
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | RF channel F |
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | RF channel G |
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | RF channel H |
| | | | | | | | | | 10 | 11 | 12 | 13 | 14 | 15 | 16 | 17 | 18 | |

Table 2 below illustrates an example time division pattern for the DMO Alternative Control Channel method, for a DGS containing groups A-H:

TABLE 2
Example TDP for DACC method.

| * | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | RF channel A |
|---|---|---|---|---|---|---|---|---|---|---|---|---|---|---|---|---|---|---|
| | | | | | | | | | 10 | 11 | 12 | 13 | 14 | 15 | 16 | 17 | 18 | |
| Fn 1 | Fn 2 | Fn 3 | * | Fn 5 | Fn 6 | Fn 7 | Fn 8 | Fn 9 | Fn | Fn | Fn | Fn | Fn | Fn | Fn | Fn | Fn | RF channel B |
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | * | Fn 8 | Fn 9 | Fn | Fn | Fn | Fn | Fn | Fn | Fn | Fn | Fn | RF channel C |
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | * | Fn | Fn | Fn | Fn | Fn | Fn | Fn | Fn | Fn | RF channel D |
| | | | | | | | | | 10 | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | Fn 9 | * | Fn | Fn | Fn | Fn | Fn | Fn | Fn | Fn | RF channel E |
| | | | | | | | | | | 11 | 12 | 13 | 14 | 15 | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | * | Fn | Fn | Fn | Fn | Fn | RF channel F |
| | | | | | | | | | 10 | 11 | 12 | | 14 | 15 | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | * | Fn | Fn | Fn | RF channel G |
| | | | | | | | | | 10 | 11 | 12 | 13 | 14 | | 16 | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | Fn | * | Fn | Fn | RF channel H |
| | | | | | | | | | 10 | 11 | 12 | 13 | 14 | 15 | | 17 | 18 | |
| Fn 1 | Fn 2 | Fn 3 | Fn 4 | Fn 5 | Fn 6 | Fn 7 | Fn 8 | Fn 9 | Fn | Fn | Fn | Fn | Fn | Fn | Fn | Fn | Fn | Alternative |
| | | | | | | | | | 10 | 11 | 12 | 13 | 14 | 15 | 16 | 17 | 18 | channel |

In tables 1 and 2 above, frames 6, 12, and 18 are used by the master MSs for synchronization, as per the TETRA standard.

If a DGS in a TETRA system comprises more than 8 groups, other time slots may be utilised (for example, time slot 3 of frames 2, 5, 8, 11, 14 and 17 above, normally reserved for slave or idle but occupied MSs, and wherein any clashes that may occur from the slave or idle MSs perspective are recoverable by retransmission processes within the standard).

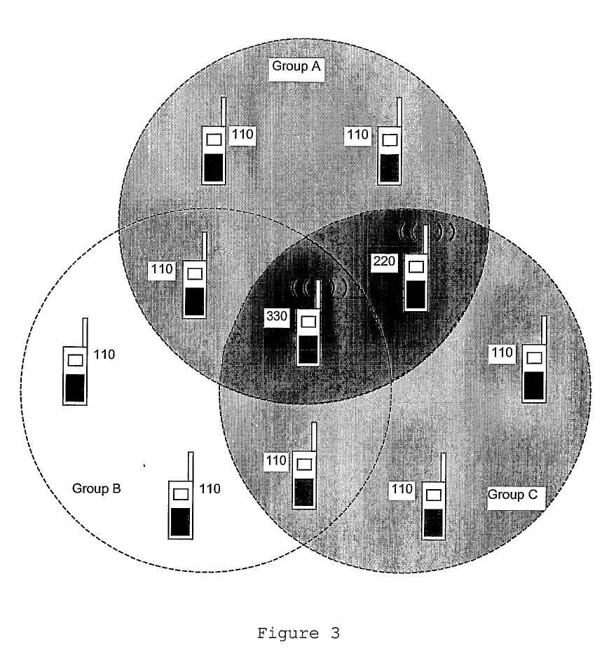

Referring finally to FIG. 3, an MS 330 of a high-ranking manager is depicted initiating a call or service to a group comprising the mid-ranking manager's MS 220, but different to that group to which the mid-ranking manager's MS 220 itself is making a call.

When an additional active group is detected, the MS (110, 220) may alert the user to the activity. However, a number of strategies are possible in this regard. For example, groups within the DGS may be assigned a rank, so that activity on a high ranking group results in automatic switching from lower ranking calls to that group (in accordance with the prevailing standard procedures), or in prioritising channel activity information to the user.

In a similar vein, individual master MSs corresponding to key personnel, identified via their presence signal burst, may be ranked in a similar manner for switching or information purposes.

Finally, not all MSs may be granted access to all groups in the DGS, and so not alert their users to activities in these groups. Indeed, in an alternative embodiment of the present invention, an MS (110, 220) will only monitor those time slots in the DCCC and DACC schemes relevant to groups that they are entitled to join.

In the scenario of FIG. 3, therefore, the mid-ranking manager may be made aware of the high-ranking manager's call, and may wish to end his or her own call to join. Thus the chain of information or command can be maintained in direct mode operation in this scenario.

In the event of an undesired presence signal burst (i.e. an unexpected target address in a specific time slot) for example caused by an MS coming within range that does not share the common DGS, then a TETRA MS (110, 220, 330) shall activate an appropriate counter to time out the undesired call/service. Similarly, if unexpected messages are decoded or not messages are received when expected (e.g due to cyclic redundancy check, or CRC errors), other counters shall be started to time out the service. All other DMO timers and counters are retained and handles as per the TETRA DMO standard.

It will be understood that the method of direct mode radio communication as described above, provides at least one or more of the following advantages in direct mode operation:
i. MSs are able to scan multiple channels when there are currently no group calls or services;
ii. MSs are able to scan multiple channels when there are currently one or more group calls or services;
iii. MSs can inform the user about calls or services occurring on other channels, or automatically switch to more important calls or services.
iv. Chains of information or command are not necessarily broken by ignorance of other channel activity.

1-19. (canceled)

20. A method of radio communication comprising:
at a mobile station:
maintaining at least a first communication group set comprising an ordered list of two or more user groups for the purpose of scanning for radio frequency activity among some or all of the groups; and
conducting a surveillance procedure periodically to determine if there is any radio frequency activity comprising a communication amongst the group;
wherein the first communication group set comprises user groups (A, B, C) which communicate together by direct mode communication on an associated direct mode radio frequency channel for the group, and
wherein each of the direct mode radio frequency channels associated with the groups of the ordered list is sampled periodically to determine if there is any radio frequency activity comprising a direct mode communication on the direct mode radio frequency channel.

21. The method according to claim 20 wherein each of the direct mode radio frequency channels is sampled to detect a presence signal indicating presence of a particular group associated with the direct mode channel on the direct mode channel.

22. The method according to claim 20 wherein samples of some or all consecutive group radio frequency channels whose state is free or unknown are conducted in a single frame.

23. The method according to claim 20 wherein if there is currently no group activity on any of the surveyed channels, then a mobile station acting as a first master mobile station initiating a call or service to start on any of the groups determines a physical and logical time division pattern for all surveyed channels.

24. The method according to claim 20 wherein all other mobile stations detecting a first call or service, synchronise to the time division pattern, adopting the same frame and slot numbering as a first master mobile station.

25. The method according to claim 23 wherein each master mobile station making a direct mode call transmits a presence signal in a specific time slot to indicate a group to which the call relates.

26. The method of direct mode radio communication according to claim 25 wherein the specific time slot in which a master mobile station transmits a presence signal is related to a position within the ordered list of the group that the master mobile station is communicating with.

27. The method of direct mode radio communication according to claim 26 wherein the specific time slot in which the master mobile station transmits is within a TETRA request bit map associated frame related to the position within the ordered list of the group that the master mobile station is communicating with.

28. The method of direct mode radio communication according to claim 26 wherein the master mobile station signals all call or service recipients that the TETRA request bit map associated time slots are not available for random access requests.

29. The method of direct mode radio communication according to claim 26 wherein any slave or idle mobile station surveys a specific time slot on a relevant channel to determine if there is any radio frequency activity, the time slot channel being related to the position within the ordered list of the group that the slave or idle mobile station is currently surveying.

30. A mobile station for direct mode communication comprising:
storage means storing at least a first direct mode group set comprising an ordered list of two or more user groups together with their respective associated direct mode radio frequency channels, for the purpose of scanning for alternative radio frequency activity among some or all of the groups;
wherein the mobile station is operable, for those groups in the ordered list whose radio frequency channel state is free or unknown, to conduct a channel surveillance procedure wherein each of the direct mode radio frequency channels associated with the groups of the ordered list is sampled periodically to determine if there is any radio frequency activity comprising a direct mode communication.
